(19) United States
(12) Patent Application Publication
(10) Pub. No.: US 2025/0148298 A1
(43) Pub. Date: May 8, 2025

(54) VISUALIZING NEURONS IN AN ARTIFICIAL INTELLIGENCE MODEL

(71) Applicant: AUTOBRAINS TECHNOLOGIES LTD., Tel Aviv -Yafo (IL)

(72) Inventors: Julius Engelsöy, Tel Aviv-Yafo (IL); Armin Biess, Ness Ziona (IL); Issac Misri, Tel Aviv-Yafo (IL); Joey Hendry, Tel Aviv-Yafo (IL)

(73) Assignee: AUTOBRAINS TECHNOLOGIES LTD., Tel Aviv -Yafo (IL)

(21) Appl. No.: 18/504,834

(22) Filed: Nov. 8, 2023

(51) Int. Cl. G06N 3/10; G06N 3/084

(52) U.S. Cl. CPC G06N 3/105; G06N 3/084

(57) ABSTRACT

A method for visualizing neurons in an Artificial Intelligence (AI) model for autonomous driving. The method includes obtaining, from a number of neurons of the AI model for a task, one or more neurons; determining, for each of the one or more neurons, a respective Region of Interest (ROI) of an input related to the task, wherein the respective ROI is encoded by the one or more neurons for the task; and producing a human-interpretable representation of the determined respective ROI of the input for at least a portion of the one or more neurons, by applying a first operation including Layer-wise Relevance Propagation (LRP).

### TECHNICAL FIELD

The present disclosure relates to the field of computer technology, and more particularly, to a method, non-transitory computer-readable storage medium and computer-implemented system for visualizing neurons in an Artificial Intelligence (AI) model for autonomous driving.

### BACKGROUND

As computing and vehicular technologies continue to evolve, autonomy-related features have become more powerful and widely available, and capable of controlling vehicles in a wider variety of circumstances. For automobiles, for example, the Society of Automotive Engineers (SAE) has established a standard (J3016) that identifies six levels of driving automation from “no automation” to “full automation”. The SAE standard defines Level 0 as “no automation” with full-time performance by the human driver of all aspects of the dynamic driving task, even when enhanced by warning or intervention systems. Level 1 is defined as “driver assistance”, where a vehicle controls steering or acceleration/deceleration (but not both) in at least some driving modes, leaving the operator to perform all remaining aspects of the dynamic driving task. Level 2 is defined as “partial automation”, where the vehicle controls steering and acceleration/deceleration in at least some driving modes, leaving the operator to perform all remaining aspects of the dynamic driving task. Level 3 is defined as “conditional automation”, where, for at least some driving modes, the automated driving system performs all aspects of the dynamic driving task, with the expectation that the human driver will respond appropriately to a request to intervene. Level 4 is defined as “high automation”, where, for only certain conditions, the automated driving system performs all aspects of the dynamic driving task even if a human driver does not respond appropriately to a request to intervene. The certain conditions for Level 4 can be, for example, certain types of roads (e.g., highways) and/or certain geographic areas (e.g., a geofenced metropolitan area which has been adequately mapped). Finally, Level 5 is defined as “full automation”, where a vehicle is capable of operating without operator input under all conditions.

Artificial intelligence and machine learning have seen significant advancements, particularly in the realm of neural network models. These models, including Multilayer Perceptrons (MLPs), Convolutional Neural Networks (ConvNets), Recurrent Neural Networks (RNNs), and Transformers, have gained widespread recognition for their exceptional ability to handle complex tasks and achieve impressive performance across diverse domains. However, it is challenging to understand the underlying computations of these models due to their intricate and layered architectures. Generally, they consist of multiple interconnected layers with highly non-linear activation functions. Additionally, these models involve a substantial number of parameters, often in the order of millions, requiring extensive training to determine the optimal values for these parameters. While these complex architectures and parameters enable the models to capture complicated patterns and relationships in the input data, they also contribute to the opaque, “black-box” nature of these models, where it is difficult for a user to understand how a model arrived at its prediction, decision, or action. The combination of a large number of parameters and intricate architectures amplifies the difficulty in interpreting and comprehending the inner workings of these models. The underlying computations and decision-making processes within these models often remain opaque, making it challenging to understand how the models arrive at their predictions or classifications. The absence of transparency raises concerns in various fields, including legal, medical, and commercial applications, where interpretability and explainability are significant considerations.

This lack of interpretability not only hampers human's ability to trust and explain the decisions made by the models, but also impedes attempts to identify potential biases or errors in their predictions. Also, the computational efficiency of the models suffers, as the allocation of limited computer resources such as neurons and the associated electrical energy used to power their decision making and implementation to complete assigned tasks and to learn from errors go unchecked. Also, model accuracy decreases over time, as errors and biases in their predictions that lead to serious mistakes become undetected and unfixed.

Addressing these challenges is important to increase trust and adoption of neural network models in real-world applications by increasing computational efficiency and model accuracy, as model providers and even end-users have an increasing need for a clear understanding of the model's decision-making process, while achieving computational cost and energy reduction. Additionally, transparent and interpretable neural network models can facilitate the identification and mitigation of biases and discriminatory patterns, ensuring fairness and accountability in automated decision-making systems while improving model accuracy that prevent serious mistakes due to biases and prediction errors. Thus, continuing efforts are being made to turn neural networks models into more transparent or “white-box” models.

Various techniques have been proposed, including model post-hoc interpretability methods and the use of explainable AI frameworks. Post-hoc interpretability methods aim to provide explanations for model predictions after they have been generated, while explainable AI frameworks focus on designing models with built-in interpretability from the outset. However, post-hoc interpretability methods and explainable AI frameworks each have their own deficiencies. Post-hoc methods often provide approximations of the model's behavior, which may not accurately capture the underlying model's decision-making process. Some post-hoc methods rely on model-specific details, making them less applicable to various AI models and architectures. Explainable AI frameworks may not scale well for very large and complex models, slowing down the interpretability process in practical scenarios. Thus, addressing deficiencies in terms of limited accuracy, model dependencies, and/or scalability such as in post-hoc interpretability methods and explainable AI frameworks also becomes an emerging challenge in pursuit of improving interpretability and explainability of neural network models.

As neural network models have been increasingly embedded in and have become integral to autonomous driving systems, it is important to develop algorithms and systems that enhance the interpretability of these models to make autonomous driving systems more trustworthy and acceptable, aid model developers or end-users in understanding the systems' neural network decision-making processes. It is also important to develop algorithms and systems that reduce computational cost and associated energy use on limited resources, while improving accuracy of model inference of various kinds of AI models.

### SUMMARY

Embodiments of the present disclosure provide a method, a non-transitory computer-readable storage medium and a computer-implemented system for visualizing neurons in an Artificial Intelligence (AI) model that is generic or dedicated to a specific application scenario, for example, decision-making and more particular, autonomous driving. In some embodiments, the method may include obtaining, from a number of neurons of the AI model for a task, one or more neurons; determining, for each of the one or more neurons, a respective Region of Interest (ROI) of an input related to the task, wherein the respective ROI is encoded by the one or more neurons for the task; and producing a human-interpretable representation of the determined respective ROI of the input for at least a portion of the one or more neurons, by applying a first operation including Layer-wise Relevance Propagation (LRP).

In some embodiments, the input is collected by a sensor, a recorded human driving database, and/or a cloud storage for the task.

Also, in some embodiments, the input is a processed image frame, and the respective Region of Interest (ROI) for each of the one or more neurons includes a set of pixels of the processed image frame that corresponds to the respective ROI.

Further, in some embodiments, the input is a sequence of processed image frames, and the respective Region of Interest (ROI) for each of the one or more neurons includes a union of sets of pixels of the sequence of processed image frames that correspond to a respective sub-region of interest (sub-ROI) of each processed image frame in the sequence of processed image frames, respectively.

Also, in some embodiments, the producing of the human-interpretable representation includes applying a second operation including Visual Back-Propagation (VBP).

Further, in some embodiments, the Visual Back-Propagation (VBP) is applied sequentially after the Layer-wise Relevance Propagation (LRP).

Also, in some embodiments, the Artificial Intelligence (AI) model includes a mixing block and a model backbone.

Further, in some embodiments, the applying of the first operation and the second operation includes applying the Layer-wise Relevance Propagation (LRP) through the mixing block to obtain weight masks for feature maps of the one or more neurons; weighting the feature maps of the one or more neurons using the weight masks to obtain weighted feature maps of the one or more neurons; and applying the Visual Back-Propagation (VBP) to back-propagate the weighted feature maps of the one or more neurons through the model backbone.

Also, in some embodiments, the input is a spectrogram of a speech segment.

Additionally, embodiments of the present disclosure provide a non-transitory computer-readable storage medium having stored thereon instructions that, when executed by one or more processors, cause the one or more processors to execute operations including obtaining, from a number of neurons of the AI model for a task, one or more neurons; determining, for each of the one or more neurons, a respective Region of Interest (ROI) of an input related to the task, wherein the respective ROI is encoded by the one or more neurons for the task; and producing a human-interpretable representation of the determined respective ROI of the input for at least a portion of the one or more neurons, by applying a first operation including Layer-wise Relevance Propagation (LRP).

In some embodiments, the input is collected by a sensor, a recorded human driving database, and/or a cloud storage for the task.

Also, in some embodiments, the input is a processed image frame, and the respective Region of Interest (ROI) for each of the one or more neurons includes a set of pixels of the processed image frame that corresponds to the respective ROI.

Further, in some embodiments, the input is a sequence of processed image frames, and the respective Region of Interest (ROI) for each of the one or more neurons includes a union of sets of pixels of the sequence of processed image frames that correspond to a respective sub-region of interest (sub-ROI) of each processed image frame in the sequence of processed image frames, respectively.

Also, in some embodiments, the producing of the human-interpretable representation includes applying a second operation including Visual Back-Propagation (VBP).

Further, in some embodiments, the Visual Back-Propagation (VBP) is applied sequentially after the Layer-wise Relevance Propagation (LRP).

Also, in some embodiments, the Artificial Intelligence (AI) model includes a mixing block and a model backbone.

Further, in some embodiments, the applying of the first operation and the second operation includes applying the Layer-wise Relevance Propagation (LRP) through the mixing block to obtain weight masks for feature maps of the one or more neurons; weighting the feature maps of the one or more neurons using the weight masks to obtain weighted feature maps of the one or more neurons; and applying the Visual Back-Propagation (VBP) to back-propagate the weighted feature maps of the one or more neurons through the model backbone.

Also, in some embodiments, the input is a spectrogram of a speech segment.

Furthermore, embodiments of the present disclosure provide computer-implemented system including one or more processors; and one or more memory devices that store instructions that, when executed by the one or more processors, cause the one or more processors to execute operations including obtaining, from a number of neurons of the AI model for a task, one or more neurons; determining, for each of the one or more neurons, a respective Region of Interest (ROI) of an input related to the task, wherein the respective ROI is encoded by the one or more neurons for the task; and producing a human-interpretable representation of the determined respective ROI of the input for at least a portion of the one or more neurons, by applying a first operation including Layer-wise Relevance Propagation (LRP).

In some embodiments, the producing of the human-interpretable representation includes applying a second operation including Visual Back-Propagation (VBP).

It should be understood that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF DRAWINGS

To illustrate the embodiments of the present disclosure or related art more clearly, the following figures will be described in the embodiments are briefly introduced. It is obvious that the drawings are merely some embodiments of the present disclosure, a person having ordinary skill in this field may obtain other figures according to these figures without paying the premise. The arrows in the figures indicate a relationship whereby the component the arrow is pointing to is trained/applied using the component the arrow is pointing from. The embodiments of the disclosure will be understood and appreciated more fully from the following detailed description, taken in conjunction with the drawings in which:

FIG. 1A is a block diagram illustrating an example of an Artificial Intelligence (AI) model, in accordance with some embodiments of the present disclosure;

FIG. 1B is a block diagram illustrating an example of a trained Artificial Intelligence (AI) model suitable for performing a method for visualizing the model, in accordance with some embodiments of the present disclosure;

FIG. 2 is a block diagram illustrating an example of the proposed computer-implemented system, in accordance with some embodiments of the present disclosure;

FIG. 3A is a diagram illustrating an example of a Region of Interest (ROI) within an input image, in accordance with some embodiments of the present disclosure;

FIG. 3B is a diagram illustrating an example of a set of sub-Regions of Interest (sub-ROIs) in a sequence of input images, in accordance with some embodiments of the present disclosure;

FIG. 4 is a diagram illustrating an example of a spectrogram respectively represented in three-dimensional (3D) and two-dimensional (2D) form that aid with the visualization of neurons within an AI model, in accordance with some embodiments of the present disclosure;

FIG. 5 is a flowchart illustrating an example of operations of visualizing neurons in an AI model, in accordance with some embodiments of the present disclosure;

FIG. 6 is a flowchart illustrating another example of operations of visualizing neurons in an AI model, in accordance with some embodiments of the present disclosure;

FIG. 7 is a flowchart illustrating an example of operations of applying two saliency-map based visualization techniques, in accordance with some embodiments of the present disclosure;

FIG. 8 is an illustration of an example of producing a human-interpretable representation, in accordance with some embodiments of the present disclosure;

FIG. 9 is an illustration of another example of producing a human-interpretable representation, in accordance with some embodiments of the present disclosure;

FIG. 10 is an illustration of yet another example of producing a human-interpretable representation, in accordance with some embodiments of the present disclosure; and

FIG. 11 illustrates an example hardware and software environment for an autonomous vehicle, in accordance with some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure. In the following detailed description, numerous specific details are set forth to provide a thorough understanding of the invention. However, it will be understood by those skilled in the art that the present invention may be practiced without these specific details. In other instances, well-known methods, procedures, and components have not been described in detail so as not to obscure the present invention. The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention. For example, the specification and/or drawings may refer to a processor or to a processing circuitry. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The following specification and/or drawings may refer to an image or an image frame. An image is an example of a media unit. Any reference to an image may be applied mutatis mutandis to a media unit. A media unit may be an example of a sensed information unit (SIU). Any reference to a media unit may be applied mutatis mutandis to any type of natural signal such as but not limited to signal generated by nature, signal representing human behavior, signal representing operations related to the vehicle signals, geodetic signals, geophysical signals, textual signals, numerical signals, time series signals, and the like. Any reference to a media unit may be applied mutatis mutandis to the SIU. The SIU may be of any kind and may be sensed by any type of sensors-such as a visual light camera, an audio sensor, a sensor that may sense infrared, radar imagery, ultrasound, electro-optics, radiography, Light Detection and Ranging (LIDAR), a thermal sensor, a passive sensor, an active sensor, etc. The sensing may include generating samples (e.g., pixel, audio signals, etc.) that represent the signal that is transmitted, or otherwise reach the sensor. The SIU may have one or more images, one or more video clips, textual information regarding the one or more images, text describing kinematic information, and the like.

Any combination of any module or unit listed in any of the figures, any part of the specification and/or any claims may be provided. Any one of the units and/or modules that are illustrated in the application, may be implemented in hardware and/or code, instructions and/or commands stored in a non-transitory computer readable medium, may be included in a vehicle, outside a vehicle, in a mobile device, in a server, and the like. The vehicle may be any type of vehicle—for example a ground transportation vehicle, an airborne vehicle, or a water vessel. The vehicle is also referred to as an ego-vehicle. It should be understood that the autonomous driving includes at least partially autonomous (semi-autonomous) driving of a vehicle, which includes all the L2 level types or higher defined in the SAE standard.

As used herein, an Artificial Intelligence (AI) model may be generic or dedicated to a specific application scenario, for example, decision-making, classifications, predictions, etc. In particular, the AI model may be tailored for regular tasks related to autonomous driving. These tasks may for example be categorized into perception, localization and mapping, planning and decision-making, and control. Perception tasks involve accurate detection and recognition of objects and entities in the surrounding environment. This includes identifying and classifying pedestrians, vehicles, traffic signs, traffic lights, and other relevant objects. Localization tasks focus on determining the precise position of a vehicle in its surroundings which involves utilizing sensors and data to estimate the vehicle's location relative to a known reference point or map, while mapping tasks, on the other hand, involve creating and updating a representation of the surrounding environment. Localization and mapping together enable an autonomous driving system to understand the vehicle's precise location and to navigate it effectively. Planning tasks involve generating a sequence of actions or a trajectory based on the vehicle's current position and desired destination. Decision-making tasks entail analyzing the current driving situation and determining appropriate actions, such as changing lanes, accelerating, braking, or yielding. Planning and decision-making together enable the autonomous driving system to navigate the vehicle in a safer and more efficient manner. Control tasks typically include executing the planned actions and adjusting the vehicle's dynamics to follow a desired trajectory. This includes controlling the steering, acceleration, and braking systems to maintain proper control and stability of the vehicle. Control tasks ensure the vehicle's physical response aligns with the planned actions.

The present disclosure proposes a method for visualizing neurons in an Artificial Intelligence (AI) model. To do so, millions of neurons in an AI model must be simplified as a prerequisite, to obtain an equivalent and yet compact representation of the whole set of neurons in the model. This facilitates the gaining an intuitive understanding of which part of the model input each of the limited number of neurons looks at in order for completing a given task. By simplifying the representation of neurons, an intuitive grasp of the neural network's response to a model input under a given task may be achieved. The simplified and compact representation of neurons allows for a more focused analysis of the model's behavior and the neurons' contribution to the overall functionality of the AI model.

As used herein, the term Region of Interest (ROI) denotes a unique aspect of the model input that is encoded by a neuron in the compact representation of the neurons with respect to the specific task for which the AI model is specifically trained. For example, in a lane-changing task related to autonomous driving, the identification of road boundaries is of paramount importance. This is because collisions with road boundaries can result in severe accidents such as vehicle rollovers or damages during the lane-changing process. Thus, for the lane-changing task, at least part of the neurons in the compact representation of the neurons of the AI model, which may also be referred to as active neurons, pay their attention to the portions of the model input that represent the lane boundaries or contain information of the lane boundaries. Each of the active neurons may then, based on the determined respective ROI, encode a respective portion of the model input such that the overall functionality of AI model (i.e., performing lane-changing of the vehicle) may be fulfilled, which necessitates preventing the vehicle from overlapping or colliding with any of the detected lane boundaries in the model input. Finally, to produce a human-interpretable representation by which end-users and/or model developers may gain an intuitive understanding of the underlying workings of the AI model, a first operation is applied. This operation utilizes Layer-wise Relevance Propagation (LRP), a technique employed to highlight the contribution of individual neurons in encoding different aspects of the overall input for completing the task. By utilizing LRP, the method generates a representation that is more easily understandable and interpretable by human. In this manner, the disclosed method provides a valuable approach to visualize and comprehend the functioning of neurons within an AI model tailored for specific application scenarios, for example, autonomous driving. Also, by focusing on the specific contribution of individual neurons, computational resources may be allocated to the specific neurons or nodes that have the highest contributions for completing the specific task, thus improving computational efficiency.

That is, based on the generated representation, users, model developers or the trained model itself can intuitively understand which specific portions of the model input each active node in the AI model is responsible for or focused on in a given task, which nodes do not participate in processing the model input (and potentially do not involve in the model's decision-making, such as model inference), which nodes are most concerned with the portions of the model input that are associated with the model's decision-making (and which nodes are less important for these portions), and so on. Accordingly, users, model developers, or the trained model can modify and/or fine-tune the network structure of the previously trained AI model for the given task based on the generated human-readable representation, such as deactivating or even removing those nodes that are less relevant to the model's decision-making, so as to save computing resources and increase computational efficiency. Additionally, using the human-readable representation generated by the method and system disclosed in the present application, model developers or the trained model can review whether it is necessary to modify the type, quantity, format, etc. of the model input to better facilitate the generation of correct model decisions, thereby improving the accuracy of the model inference for the model input in the given task and enhancing the safety and reliability of using such AI models in applications such as autonomous driving systems.

Moreover, with increased human interpretability of the AI model, the user and/or trainer may provide more accurate feedback to the AI model as reference data. Such higher quality of reference data reduces the overall amount of data required for the AI model to achieve a working model. This means the AI model requires less time and less computational resources to train its parameters to achieve a working model.

It should be noted that the disclosed method does not necessarily require involvement in the training process of an AI model, thus avoiding the need for increased computational resources. The flexibility of the disclosed method is a notable feature as it does not depend on the specific intricacies or implementation details of the AI model. Consequently, it can be effectively applied to a wide range of AI models, regardless of their architecture, size, or complexity. The scalability ensures its compatibility with various types of AI models, including neural networks, deep learning models, reinforcement learning models, or any other form of machine learning algorithms. Overall, the disclosed method provides a resource-efficient and scalable approach to gain insights from AI models by alleviating the need for additional computational resources and avoiding dependence on model-specific details, ensuring compatibility across various types of AI models, and in turn making it valuable in practical applications.

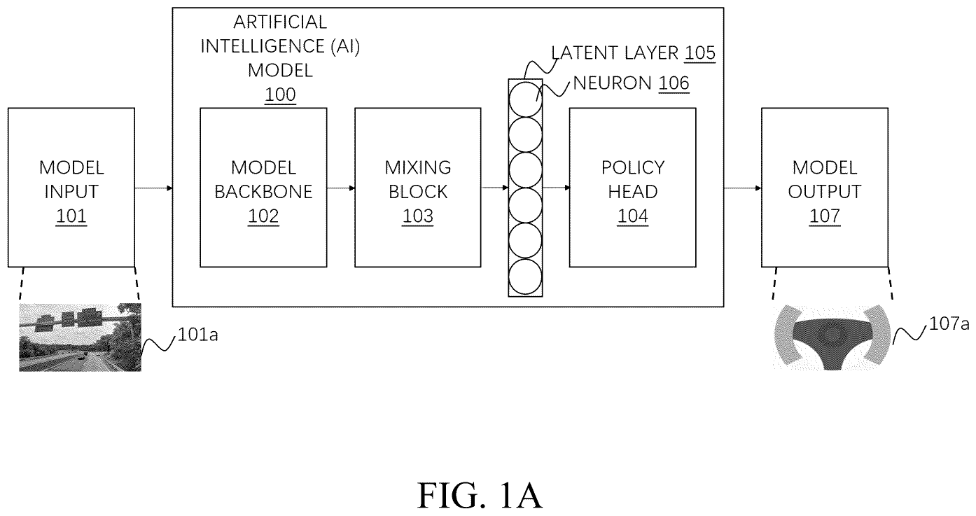

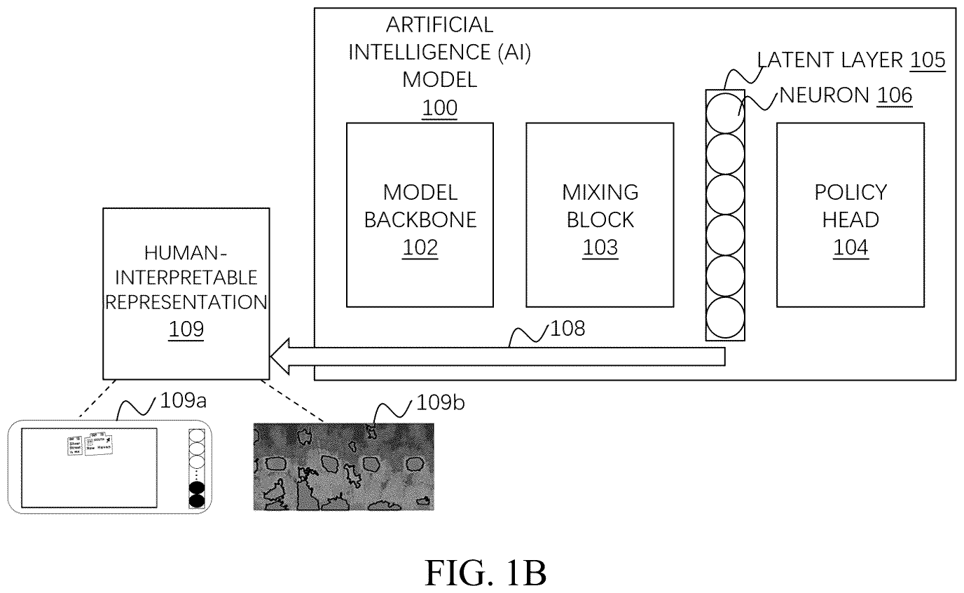

Now referring to the drawings, wherein like numbers denote like parts throughout the figures. FIG. 1A depicts a block diagram which illustrate an example of an AI model 100 according to some embodiments of the present disclosure. As shown in FIG. 1A, an AI model 100 may include a model backbone 102, a mixing block 103, a policy head 104, a latent layer 105, and a plurality of neurons 106.

The model backbone 102 constitutes a foundational part of the AI model 100, which is responsible for initial data processing. In some examples, the model backbone 102 may include various layers and modules designed to extract and transform information carried in model inputs. It captures, extracts, and classifies the essential features and representations from a large number of model input data 101 (e.g., frontal images or videos of a road, or annotations of lateral acceleration), which needed for subsequent analysis and decision-making within the AI model. In an embodiment, the model backbone 102 may be a Convolutional Neural Network (CNN) that learns different features such as lines and curves of a road.

The mixing block 103 may integrate and combine information from different parts (e.g., layers) of the model backbone 102. It enhances the overall representation of the input data by facilitating the exchange of information and feature fusion amongst the model inputs. The mixing block ensures the effective sharing and utilization of relevant information, improving the AI model's overall performance and accuracy. In an embodiment, the mixing block 103 may be a Multi-Layer Perceptron (MLP), which may include channel-mixing MLPs that allow communication between different channels, and token-mixing MLPs that allow communication between different spatial locations. These layers are interleaved (i.e., combined) to enable interaction of both types of inputs.

The policy head 104 represents a component that develops a strategy and generates a final output or implementation decision based on an analysis of the processed input data. The policy head 104 also provides a higher-level understanding of the input data. In other words, the policy head dictates the action to be taken, based on the state of the deep learning model and the surrounding environment that is detected. In an embodiment, the policy head 104 may be a trainable AI model.

The latent layer 105 is a simplified or compressed representation of the model input data 101, which may include a summary of key features about the model input data 101, such as features related to lane boundaries. In some embodiments, the latent layer 105 may be obtained by dropping duplicated or extraneous data using different data representation and approximation techniques. This allows for transferring fewer data without losses and transferring compact models instead of raw data. As such, computational efficiency may be improved, as less data needs to be processed and transferred from one area to another. Also, without losses, model accuracy may be maintained.

The latent layer 105 may include multiple neurons 106, with each neuron dedicated to or focused on capturing and processing specific input features or patterns for a given task. In some examples, the latent layer 105 may serve as compact representation of a whole set of neurons within the AI model. That is, the number of neurons in the latent layer 105 is limited and tolerable in terms of human interpretation. Consequently, the collective behavior of these neurons 106 may contribute to the holistic processing of the input data within the AI model 100 in order for the task to be completed.

In operation, the AI model 100 receives, processes the model input 101, and generates the model output 107. An example of the model input 101 may be an image signal depicting a frontal view images of the road, as represented by a thumbnail 101a in the figure. However, those of ordinary skills in the field may understand that there may also be other suitable forms of model inputs, such as audio signals, text annotations or a combination of audio and image signals (e.g., video streams) along with text annotations. In some embodiments, the model input 101 is raw data from one or more sensors of a same or a separate vehicle. For example, the model input 101 may be an image captured by a camera sensor that includes Red-Green-Blue (RGB) value of pixels. The model input 101 may be a raw SIU, a processed SIU, text information, information derived from the SIU, and the like. In different embodiments, the loading of the model input 101 may be from a local disk, over a suitable “cloud” network, from a remote storage location, etc. Obtaining of the model input 101 may include receiving the data, generating the data, participating in a processing of the data, processing only a part of the data and/or receiving only another part of the data. The processing of the model input 101 may include at least one out of detection, noise reduction, improvement of signal to noise ratio, defining bounding boxes, and the like. The model input 101 may be received from one or more sources such as one or more sensors, one or more communication units, one or more memory units, one or more image processors, and the like.

From the received model input 101 the model backbone 102 extracts the features from the model input 101, such as the curvature of the road that is included in the image, lane markers, etc., and passes the extracted features to the mixing block 103. Here, the features are combined with other layers and reduced from high dimensional model input data into a low dimensional latent vector, as a compressed latent layer 105. In such a manner, the data volume/complexity of the raw data 102 may be reduced by forming the compressed latent layer 105. Such compression further improves computational efficiency, as less data would need to be learned and processed, as described in more detail below.

The latent layer 105 of the model input 101 helps to learn the data characteristics and simplify data representations. Each of the data characteristics is stored as individual neurons 106. The policy head 104 receives the latent layer 105, processes the information given by the latent layer, which may include the above curvature of the road, lane markers, and additionally the current positions of a vehicle relative to the road, its current speed and lateral acceleration, whether there are other vehicles nearby, etc., and outputs a model output 107 according to the processed information. In an embodiment, the model output 107 may include an output driving operation decision to turn a steering wheel 107a to increase lateral acceleration and keep the vehicle centered within a curving lane.

In some embodiments, the model backbone 102 and the mixing block 103 may be configured to map the model input 101 into the latent layer 105, which may be stored in a database of semantic relations. In some embodiments, the model backbone 102 learns the input data dimension compression to encode the features' latent representation, whereas the policy head 104 recreates the encoded latent representation to a reconstructed output such as the model output 107. For example, the model backbone 102 may be configured to generate compressed latent layer 105 of the model input 101 with a one-dimensional vector, representing one or more elements of the model input 101. In one embodiment, the compressed latent layer 105 may be expressed as a vector V, wherein V=[E1, E2, E3, . . . . EN], E1 means element 1, E2 means element 2, E3 means element 3, EN means element N. Each element may be a single or plural dimensional matrix. Each element may represent a potentially useful feature of the surroundings of the vehicle, such as lane borderlines, lane centerline, vehicles nearby, traffic signs, tree contours, etc.

The model backbone 102 may be configured to encode meaningful information about various data attributes in its latent manifold which can then be exploited to carry out pertinent tasks. In such embodiments, the latent layer 105 helps to reduce the dimensionality of the input data and to eliminate non-relevant information. Thus, the dimensionality reduction of the input data may reduce computational consumption, as less computer resources need to be allocated to process the reduced complexity and volume of the input data. Also, model accuracy may be improved, as irrelevant information that may skew the modelling are eliminated.

In some embodiments, given the latent layer 106, the policy head 104 may be configured to determine the behavior that a vehicle needs to follow from a set of predefined tasks. The tasks determine the actions that an autonomous car needs to take based on the latent layer 105. Some examples of these tasks are lane keeping, overtaking another car, changing lanes, intersection handling, and traffic light handling, among others.

The model output 107 may represent an action to be performed in the context of a specific application scenario such as autonomous driving, for instance, manipulation of the gas pedal, brake pedal, or the steering wheel, the latter of which is indicated by a thumbnail 107a in the figure. Although the depicted components in FIG. 1 are shown to constitute an AI model, it is readily appreciated that AI models tailored for specific application scenarios (e.g., decision-making, autonomous driving, etc.) can also be generalized as including similar components as shown in FIG. 1A.

FIG. 1B depicts a block diagram which illustrates an example of a trained AI model suitable for performing a method for visualizing the model according to some embodiments of the present disclosure. The main difference between FIG. 1B and FIG. 1A lies in the fact that the AI model 100 as depicted in FIG. 1B has completed its training process, and therefore, all parameters of the AI model have been determined. Hence, in FIG. 1B, the connections between various components are intentionally omitted, which are depicted in FIG. 1A to illustrate the data flow during the model training process. As shown in FIG. 1B, an arrow may indicate an operation which will be described in more detail below. In an embodiment the operation performed is an LRP.

LRP is a technique used in the field of artificial intelligence and deep learning to understand the contribution and relevance of input features towards a model's output. LRP allows for the interpretation and analysis of neural network models by propagating relevance scores backwards through the layers of the network. In particular, LRP operates by assigning relevance scores, or weights, to the output neurons (i.e., neural activations) of the model, which may alternatively be neurons 106 in the latent layer 105 in the present disclosure, and then propagating these scores back through the layers or model components. This backward propagation process aims to highlight the importance of different input features and their classifications for which the neurons, for example, neurons 106 use in formulating the model's decision-making process. By applying LRP, it is possible to generate a human-interpretable representation that emphasizes the regions of the input data that are most relevant to (i.e., visualize the input pixel that really contributed to) the model's decision from the perspective of neurons. Therefore, computational efficiency may be confirmed and further improved, as limited computer resources may be further allocated to input deemed as most important to the model's decision for more focused processing based on LRP application. LRP has widespread applications, including image classification, natural language processing, and other areas where AI models are employed.

As depicted in FIG. 1B, the human-interpretable representation 109 may be a Graphical User Interface (GUI) representation obtained by applying the LRP operation towards the model input 101 in FIG. 1. An example of such a representation is demonstrated by a thumbnail 109a in FIG. 1B, where such a representation demonstrates a mapping between the selected one (or group) of the active neurons of the AI model 100 and its (their) concerned portion in the model input for execution of the given task. Another example is a thumbnail 109b for which the given task may be speech-related, for instance voice control in autonomous driving. The saliency portions as outlined in the thumbnail 109b within a model input, for example, a 2D representation of spectrogram of the speech, may be correlated with respective active neurons, reflecting what the latent layer encodes for completion of the speech-related driving task. Details regarding examples of the human-interpretable representation 109 will be described hereinafter.

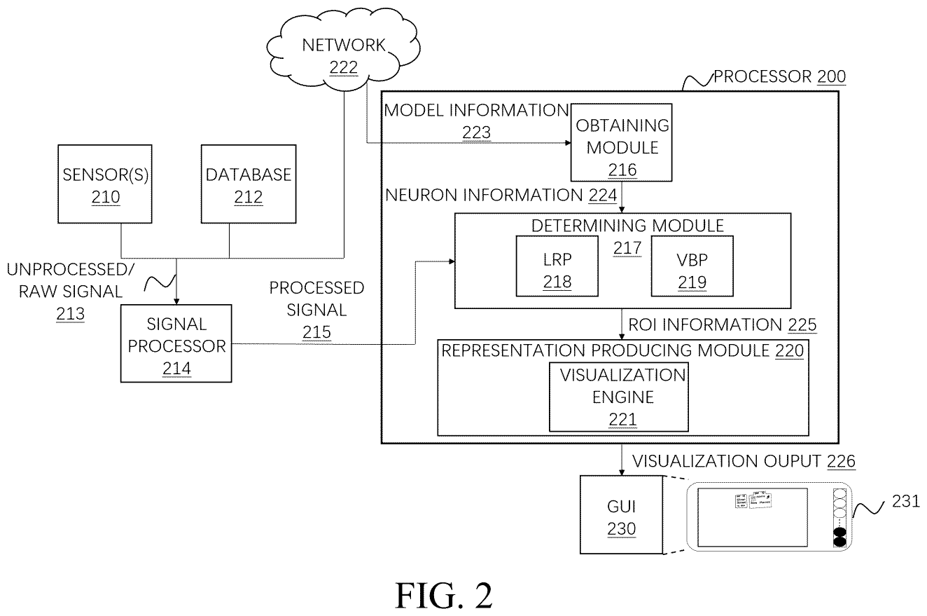

FIG. 2 depicts a block diagram which illustrates an example of the proposed computer-implemented system according to some embodiments of the present disclosure. As shown, the proposed computer-implemented system may include a processor 200. The processor 200 may be a general-purpose processor or a specialized processor such as ASIC (Application-Specific Integrated Circuit), FPGA (Field-Programmable Gate Array), SOC (System-on-a-Chip), CPLD (Complex Programmable Logic Device), and the like.

As shown, the processor 200 may include an obtaining module 216, a determining module 217, an LRP 218, a Visual Back-Propagation (VBP) 219, a representation producing module 220, and a visualization engine 221.

The obtaining module 216 may be configured to receive model information 223 of an AI model from a network 222, in which an AI model is deployed, and to gain knowledge of the whole set of neurons of the AI model from the received model information 223. Subsequently, the obtaining module 216 may be configured to obtain, from the number of neurons in the whole set of neurons of the AI model for a given task, one or more neurons that serve as a compact representation of the whole set of neurons and is indicated as neuron information 224. In some implementations, depending on diverse tasks at hand, the obtaining module 216 may selectively obtain different sets of one or more neurons from the whole set of neurons of the AI model. These obtained neurons form a compact representation that focuses on relevant aspects in an input required for a given task.

Processor 200 may also include a determining module 217. The determining module 217 may be configured to determine, based on the received neuron information 224, a respective ROI of an input related to the given task for each of the obtained one or more neurons as represented by the neuron information 224. As shown, the determining module 217 may include an LRP unit 218, which is configured to apply the LRP operation to a model input. As a non-limiting example, the model input may be a processed signal 215. The processed signal 215 may be output from a signal processor 214, which may be separate from the processor 200 as shown in FIG. 2. The signal processor 214 may, for example, be a Digital Signal Processor (DSP). In some examples, the processed signal 215 is output from the signal processor 214 in response to receiving an unprocessed raw signal 213. The unprocessed raw signal 213 may either be acquired from one or more sensors 210, a recorded human driving database 212, or from the network 222.

Optionally, the determining module 217 may also include a VBP 219. VBP is a technique commonly used in the field of computer vision and deep learning to gain insights into the image regions that contribute most significantly to the model's predictions. VBP operates by propagating the gradients from the output layer, which may alternatively be the latent layer 105 in FIGS. 1A and 1B, back to the input layer, thereby attributing relevance scores to each pixel or region along the way. These relevance scores signify the importance of that particular pixel or region in contributing to the model's decision. By mapping these relevance scores back to the input image, VBP facilitates the generation of visually interpretable heatmaps or saliency maps, making it a powerful tool for visualizing and interpreting neural network models, and verifying whether the prediction results outputted by the models are consistent with true values obtained. That is, by highlighting the significant image regions, VBP provides intuitive insights into the decision-making process, contributing to the transparency and interpretability of models employed in visual-related tasks. As such, model accuracy of the neural network model may be confirmed and improved. Additionally, computational efficiency may be enhanced, as the limited computer resources may be allocated to the particular pixel or regions that contribute the most to the model's decision, while eliminating ineffectively allocated resources on unnecessary input processing.

In summary, the determination module 217 within the processor 200 allows for the identification and determination of task-related ROIs in the processed signal 215 for one or more relevant (i.e., active) neurons in the latent layer based on the received neuron information 224, while enhancing model accuracy and improving computational efficiency.

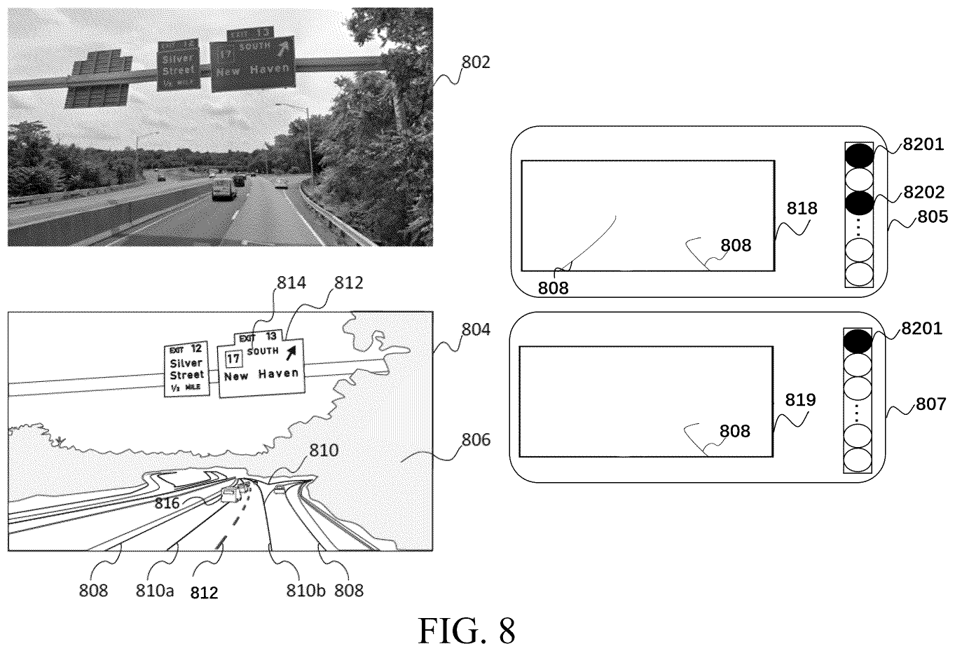

The processor 200 may further include a representation producing module 220. In some examples, the representation producing module 220 may include a visualization engine 221 that is responsible for producing a visualization output 226. This visualization output 226 may be a human-interpretable representation of the determined respective ROI of the model input (e.g., processed signal 215) for at least a portion of the obtained one or more neurons. As a non-limiting example, the visualization output 226 may be presented in a GUI 230 as shown in FIG. 2. An example of the output in the GUI may be represented by a thumbnail 231, which will be described with respect to FIGS. 8-10 hereinafter.

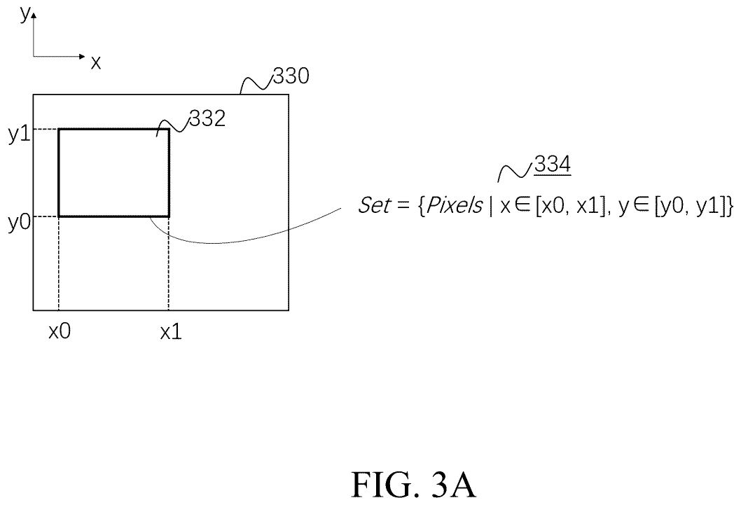

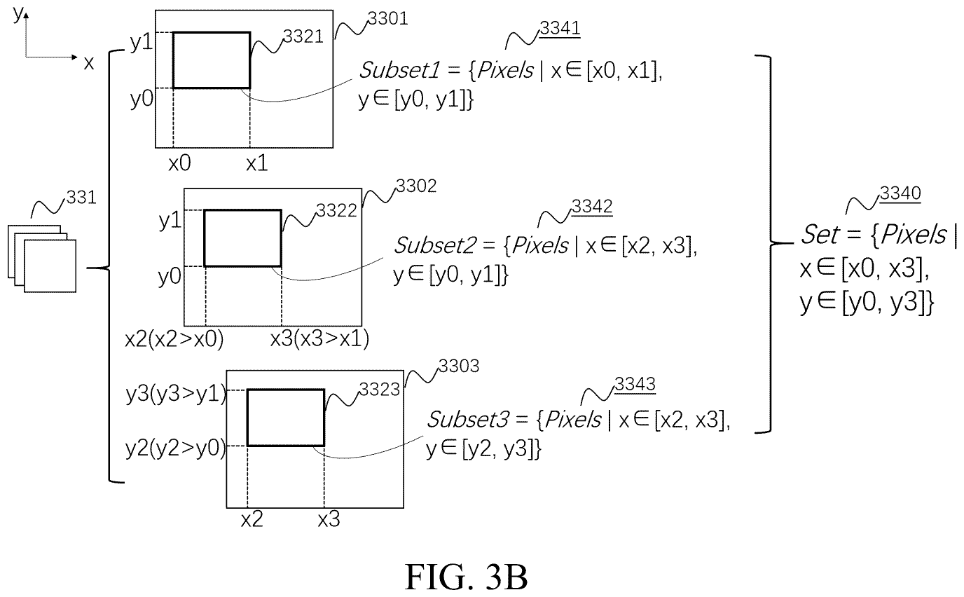

FIG. 3A depicts a diagram illustrating an example of an ROI in an input image according to some embodiments of the present disclosure. As shown, the processed signal 215 in FIG. 2 may be indicated by the reference numeral 330, which may be an image signal and subject to image processing such as grayscale and cropping. The processed signal 330 may include a ROI 332, which encompasses a rectangular region of pixels denoted by reference numeral 334, with their horizontal range spanning from x0 to x1 and vertical range spanning from y0 to y1. In an embodiment, the identification of the ROI within the processed signal 330 may be binary, in that the processed signal may either fall within the ROI, or that the signal may fall outside of the ROI.

FIG. 3B depicts a diagram illustrates an example of a set of sub-Regions of Interest (sub-ROIs) in a sequence of input images according to some embodiments of the present disclosure. Sometimes, tasks taken by AI models require multiple inputs, rather than just a single input. For instance, in the case of an overtaking task, an AI model needs a sequence of image frames to accurately assess the motion of other vehicles and/or moving objects around the ego vehicle. FIG. 3B thus intends to illustrate such application scenarios. In FIG. 3B, it depicts an example where a sequential of image frames 331 are fed into the AI model to analyze the surrounding environment during an overtaking process. The sequence of image frames may include, for example, three consecutive processed images 3301-3303 that are captured and processed in a chronological order. The processed images 3301-3303 each may include a respective sub-ROI. As a non-limiting example, the sub-ROI in the processed images 3301 encompasses a rectangular region of pixels denoted by reference numeral 3321, with their horizontal range spanning from x0 to x1 and vertical range spanning from y0 to y1; the sub-ROI in the processed images 3302 encompasses a rectangular region of pixels denoted by reference numeral 3322, with their horizontal range spanning from x2 to x3 (with x2 being greater than x0 and x3 being greater than x1) and vertical range spanning from y0 to y1; the sub-ROI in the processed images 3303 encompasses a rectangular region of pixels denoted by reference numeral 3323, with their horizontal range spanning from x2 to x3 and vertical range spanning from y2 to y3 (with y2 being greater than y0 and y3 being greater than y1).

Therefore, an ROI of the sequence of processed image frames 331 may be denoted by reference numeral 3340 where its pixels span horizontally from x0 to x3 and vertically from y0 to y3. It can be understood that the number of image frames included in the sequence of image frames 331 may be of any suitable number, and the present disclosure does not limit this. It can also be understood that the ROIs (Regions of Interest) and sub-ROIs (sub-Regions of Interest) depicted in FIGS. 3A and 3B are depicted for illustrative purposes only. In most cases, ROIs and sub-ROIs can have irregular shapes. As such, the present disclosure does not limit on the shapes of ROIs and/or sub-ROIs.

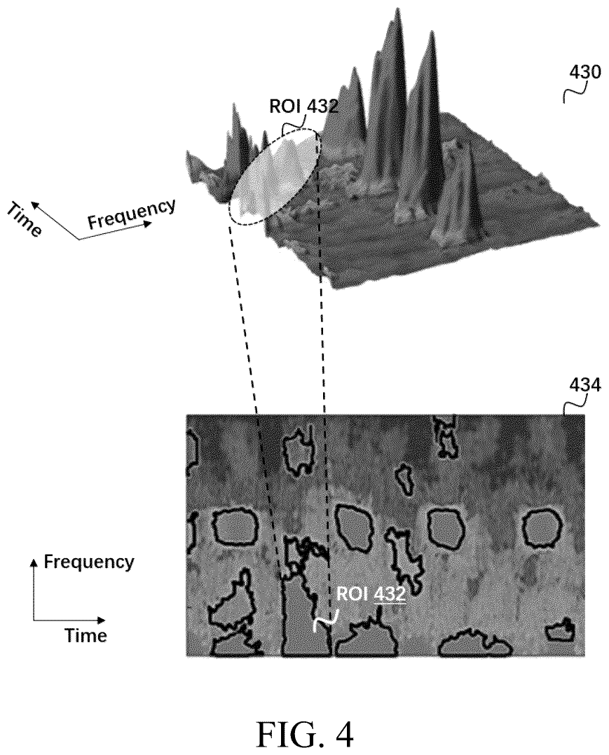

FIG. 4 depicts a diagram illustrates an example of a spectrogram respectively represented in three-dimensional (3D) and two-dimensional (2D) form according to some embodiments of the present disclosure. A spectrogram is a graphical representation of the frequency content of a signal over time. Spectrogram may be used in signal processing, for example, in audio and speech analysis. As shown in the lower portion of FIG. 4, an exemplary 2D spectrogram 434 plots the frequency spectrum of an acoustic signal (for instance, an audio signal acquired by one or more microphones arranged inside a vehicle cabin) on the y-axis and the time on the x-axis. The intensity (or color) of each point in the 2D spectrogram 434 represents the strength or magnitude of the frequency component of the acoustic signal at a specific time. It provides a visual representation of how the frequency content of the signal changes over time, allowing for analysis and identification of various audio features such as harmonics, formants, or transient events.

Additionally, the 3D spectrogram extends the concept of the 2D spectrogram by adding an additional third dimension, (i.e., the strength or magnitude of the frequency component being plotted in the third dimension versus being represented by the intensity or color in the 2D counterpart). The third dimension of the 3D spectrogram may be visualized as a surface plot or a contour plot, where the height or color of the surface/contour represents the magnitude of the frequency component at a particular time and frequency. In FIG. 4 an exemplary 3D spectrogram 430 corresponding to the 2D spectrogram 434 is shown by reference numeral 430 in the upper portion of FIG. 4.

FIG. 4 provides visual representations of a spectrogram capturing a specific fragment of an exemplary acoustic signal in both 2D and 3D formats. As shown, a distinct mountain-shaped region circled and labeled as ROI 422 in the 3D spectrogram 430 correspond to the area labeled as ROI 432 in the 2D spectrogram 434. Contents within respective ROI 432 in the 3D spectrogram 430 or 2D spectrogram 434 may pertain to vocal utterances produced by a human, such as a driver of the vehicle, while other portions in the 3D spectrogram 430 or 2D spectrogram 434 carries other components such as machine noise during vehicle operation, road ambient noise, and noise caused by other passengers inside the vehicle cabin. In practical applications, particularly in scenarios involving voice-controlled functionalities for autonomous driving, ROIs 432 signifies the salient portion within the input acoustic data of an AI model tailored for such application scenario. That is, the ROIs 432 that signifies the salient portion is the portion that the active neuron(s) within a latent layer of the model is particularly interested in, as it plays a substantial role in identification and execution of a voice command related to the autonomous driving task.

In an embodiment, the ROI may be made to be over-inclusive of the multiple features that are important for the task saliency, and the 2D spectrogram 434 or the 3D spectrogram 430 may be constructed within the identified ROIs 432 to additionally map each pixel's “level of interest,” or input relevancy to a latent neuron on a continuous scale, with the color within the 2D spectrogram 434 or the height of the 3D spectrogram 430 indicating the level of interest or saliency to the latent neuron.

Referring back to FIG. 1B, an exemplary implementation, that is thumbnail 109b, of the human-readable representation 109 depicted therein is consistent with the 2D spectrogram representation 434 shown in FIG. 4. As shown in FIG. 4, when the 2D spectrogram representation 434 is used as a human-readable representation, the contour of ROI 432 can indicate the time-frequency components of a speech signal (e.g. collected by a microphone or microphone array within the vehicle cabin) that is focused on/interested by an active node, and encoded by the active node for model decision-making. By reviewing a human-readable representation such as the 2D spectrogram representation 434, users, model developers, or the model itself can determine whether the human vocal components of the collected speech signal are sufficiently salient (e.g. whether it occupies enough area in the spectrogram), so as to adjust the settings of the speech signal sensing device (e.g. microphone) and better help the model extract useful information payloads, thereby improving the accuracy of the model inference. Alternatively, when an active node focuses on a model input part that deviates significantly from the ROI, users, model developers, or the model can save unnecessary computing resources and improve the computational efficiency involved in model inference by deactivating or removing such nodes from the network structure of the AI model.

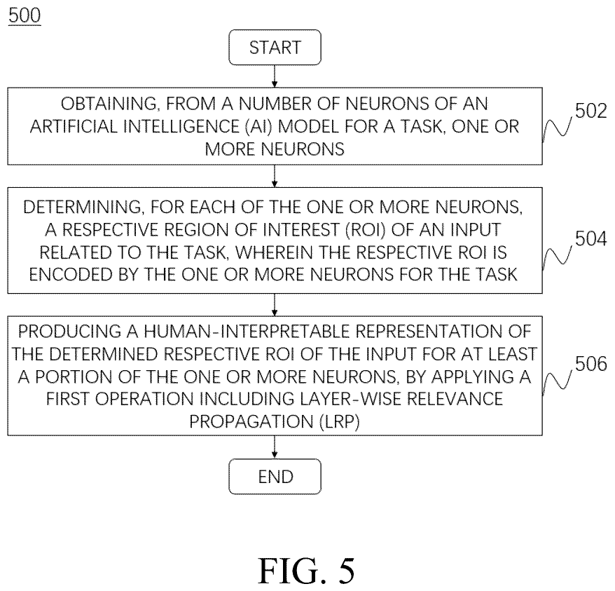

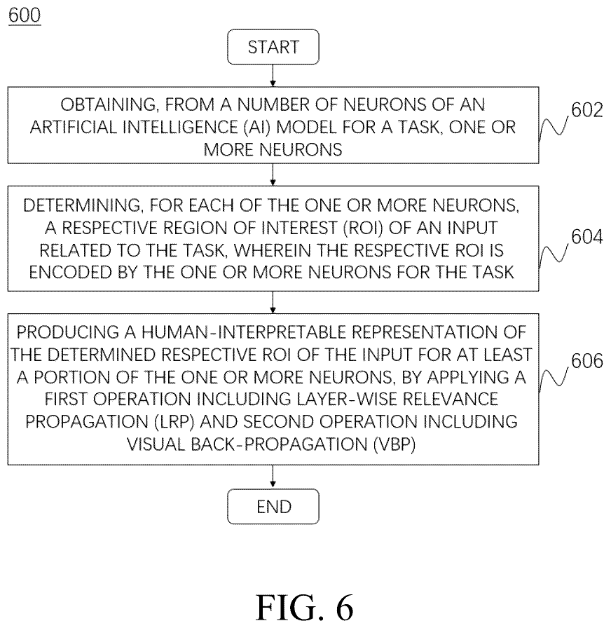

Now turning to FIGS. 5-6, these figures illustrate methods 500 and 600 corresponding to the method and models as discussed above that may be used to visualize neurons in an AI model. It is noted that the sequence of the methods 500 and 600 is exemplary and indicates no order of the steps that the methods 500 and 600 are to be performed.

Referring to FIG. 5, the method 500 starts where, at 502, one or more neurons is (are) obtained from a number of neurons of an Artificial Intelligence (AI) model for a task. Then, at 504, a respective Region of Interest (ROI) of an input related to the task is determined for each of the one or more neurons, wherein the respective ROI is encoded by the one or more neurons for the task. Thereafter, at 506, a human-interpretable representation of the determined respective ROI of the input for at least a portion of the one or more neurons is produced by applying a first operation including Layer-wise Relevance Propagation (LRP).

In some implementations of the method 500, the ROIs may be determined by a saliency map-based visualization technique such as Layer-wise Relevance Propagation (LRP). Preferably, the ROIs may be determined by a combination of saliency map-based visualization techniques such as the combination of LRP and Visual Back-Propagation (VBP). In some implementations, to facilitate human interpretation and post-hoc explainability of AI model, a relationship between the human-interpretable representation and the determined ROIs may be visualized by presenting, for example, via a GUI, a mapping between a concerned neuron of the obtained one or more neurons versus the determined ROI of the concerned neuron. As a non-limiting example, for a given task (say, lane changing task), there may be for example two active neurons related thereto in a latent layer (i.e., the compact form of the whole set of neurons) of the AI model, one for encoding the left-most lane boundary and the other for encoding the right-most lane boundary, which could for example be referred to FIG. 8 of the accompanying drawings with neurons 8201 and 8202 encode two lane boundaries 808, respectively. Accordingly, a human-interpretable representation could be demonstrated via a GUI as either (i) a mapping between the two active neurons and the two lane boundaries to which these two active neurons are looking at, or (ii) a mapping between one neuron and a respective lane boundary to which the neuron is looking at, or the like.

Also, as mentioned above, the number of neurons in the whole set of neurons of the AI model could be gigantic and thus beyond the interpretation of human. Thus, there is a need for obtaining a compact form of the whole set of neurons to simplify the black-box AI model. The compact form is the obtained one or more neurons, and they could be related to regular driving tasks, for example, each of the obtained one or more neurons may encode part of the model input related to a given task. Therefore, the underlying logic of producing a human-interpretable representation of the number of neurons contains two aspects. One aspect is to present a compact form of the whole set of neurons of the AI model instead of hundreds or thousands or millions of neurons of the model, the other aspect is to demonstrate a mapping between a selected number of the obtained one or more neurons and what the selected neuron(s) is looking/interested at in the input, such that end-users and/or model developers may understand the role of each neuron (in compact form, e.g., within the latent layer of a representation of the AI model) in encoding the model input and in turn in influencing the model's decision-making. By presenting a compact form of neurons, computational efficiency may be enhanced as less processing is required. Also, by focusing on the input that contributed most to neuron allocation to process the input, model accuracy may be confirmed and improved.

In some embodiments, the method of 600 illustrates another possible implementation of the operation of visualizing neurons in an Artificial Intelligence (AI) model. For example, the method 600 starts where, at 602, one or more neuron(s) is (are) obtained from a number of neurons of an Artificial Intelligence (AI) model for a task. Then, at 604, a respective Region of Interest (ROI) of an input related to the task is determined for each of the one or more neurons, wherein the respective ROI is encoded by the one or more neurons for the task. Thereafter, at 606, a human-interpretable representation of the determined respective ROI of the input for at least a portion of the one or more neurons is produced by applying a first operation including Layer-wise Relevance Propagation (LRP) and a second operation including Visual Back-Propagation (VBP).

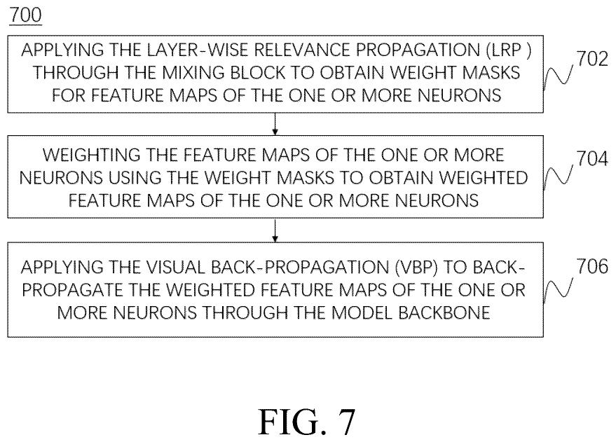

In some embodiments, as shown in FIG. 7, the method of 700 illustrates the operation the method of 700 illustrates the operation of the applying of the first and second operations as shown in Block 606 in FIG. 6. For example, the method 700 may start whereby at 702, weight masks, or masks for feature maps of the one or more neurons, are obtained by applying the LRP through a mixing block of the AI model. Then, at 704 weighted feature maps of the one or more neurons are obtained by weighting the feature maps of the one or more neurons are weighed using the obtained weight masks. Thereafter, VBP is applied to back-propagate the weighted feature maps of the one or more neurons through the model backbone. The combination of the LRP to the mixing block and VBP back propagation together further enhances the insight gained from respectively the visualization of the neurons that contributed most to the predictions made, and the region of interest from the inputted images that contributed most to the prediction made. Together the mapping of the entire image data processing to the prediction making pathway may be made, from which biases and errors may be identified. Therefore, model accuracy may be verified and improved, mistakes in predictions may be more easily identified and fixed, and computation efficiency may be improved as limited computer resources are allocated correctly to process region of interests and neurons that most affect the predictions from the neural network models.

FIGS. 8-10 are different illustrations of different examples of operating an autonomous driving system for different tasks. FIGS. 8-10 show exemplary representations of raw data 802, 902, and 1002, exemplary representations of model inputs 804, 904, and 1004, and exemplary human-interpretable representations 805, 807; 905; and 1005, 1007, respectively.

As shown in FIGS. 8-10, the raw data 802, 902, and 1002 may be captured by a camera deployed on a vehicle. The camera may be configured to capture real-time images from the perspective of a front view of the vehicle cabin. In some implementations, the model inputs 804, 904, and 1004 may be compact representations of the input images (i.e., the raw data 802, 902, and 1002) which capture useful features by a dedicated processor, for example the signal processor 214 as depicted in FIG. 1. As shown in FIGS. 8-10, the raw data 802, 902, and 1002 may be RGB images, and may carry abundant information. For example, the raw data not only includes an image of a road, but also includes images of scenes around the road, such as other vehicles, trees, traffic signs, sky, and the like. By contrast, in some implementations, the model inputs 804, 904, and 1004 retain only the useful features, and are converted into grey-scale images for ease of storage and processing by an AI model. For example, as shown in in FIGS. 8-10, the model inputs 804, 904, and 1004 may be converted from the colored raw data 802, 902, and 1002 into grey-scale images including a tree contour 806, 906, 1006; a lane boundary line 808, 908, 1008; lane centerline 810, 910, 1010 (for example, a first lane centerline 810a, 910a, 1010a; and a second lane centerline 810b, 910b, 1010b); a traffic sign contour 812, 912, 1012; a traffic sign text 814, 914, 1014; and other vehicles 816, 916, 1016.

In FIG. 8, an exemplary driving task with which an AI model embedded in or integral to the vehicle deals may be a lane-changing task. Here, there are provided two exemplary human-interpretable representations 805 and 807 for illustrative purposes only. The human-interpretable representations 805 and 807 each contains a schematic representation of a latent layer of the AI model. As described above, the latent layer may be a compact form of and equivalent to the whole set of neurons of the AI model for purpose of simplifying the black-box model. As depicted in the representation 805, two neurons 8201 and 8202 in the schematic latent layer are activated under the lane-changing task. A rectangular area 818 corresponding to the model input 806 or the raw data 802 is arranged within the representation 805 in which the respective ROIs (i.e., the left and right lane boundaries 808) of the model input determined for the two active neurons are highlighted. In some implementations, users or developers may select, from the neurons in the schematic latent layer within the GUI of the human-interpretable representation, a portion thereof so as gain an intuitive impression or understanding of what portion in the model input each active is looking at/encoding for the given task. For example, in the representation 807, only the right lane boundary 808 is highlighted within the rectangular area 819 for which a selected neuron 8201 concerns in relation to performing the lane-changing task.

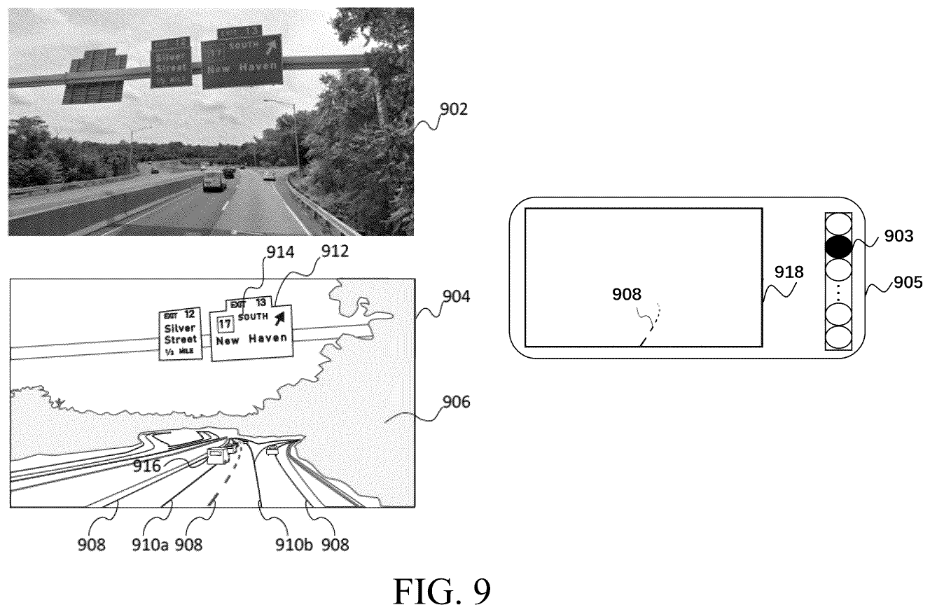

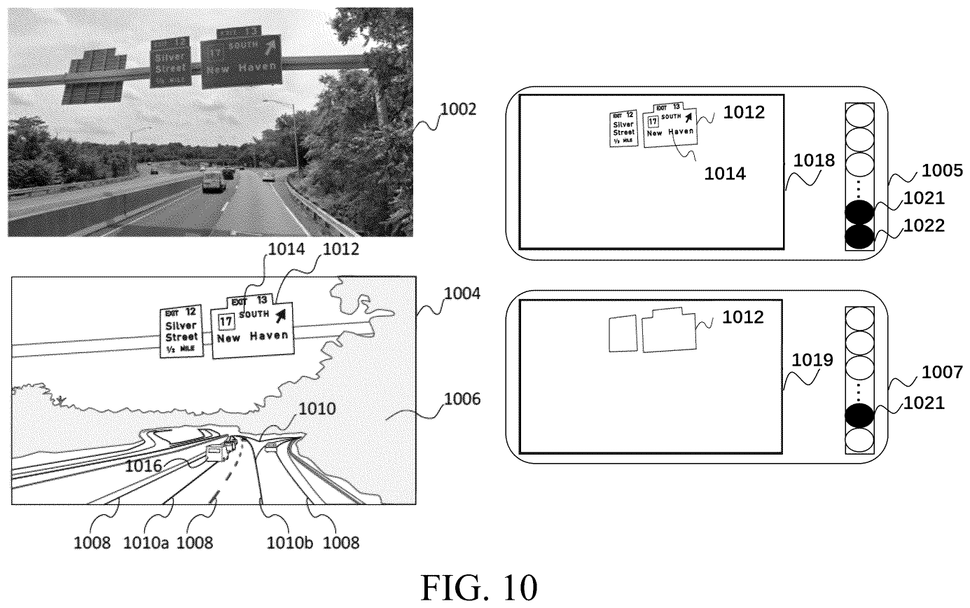

Now refer to FIGS. 9 and 10, in FIG. 9, the exemplary driving task may be a lane-centering task for which a lane centerline 908 is heighted as an ROI in the rectangular area 918, which indicates the portion of the model input that the active neuron 903 is looking at/encoding for the lane-centering task. In FIG. 10, the exemplary driving task may be a perception task under which the vehicle seeks to identify the surrounding environment for useful context information. As depicted in the representation 1005, two neurons 1021 and 1022 in the schematic latent layer are activated under the perception task. A rectangular area 1018 corresponding to the model input 1006 or the raw data 1002 is arranged within the representation 1005 in which the respective ROIs (i.e., the traffic sign contour 1012 and the traffic sign text 1014) of the model input determined for the two active neurons are highlighted. Alternatively, in the representation 1007, only the traffic sign contour 1012 is highlighted within the rectangular area 1019 for which a selected neuron 1021 concerns in relation to performing the perception task.

As shown in FIGS. 8-10, by reviewing such exemplary human-readable representations (e.g., 805, 807; 905; 1005, 1007), users, model developers, or the model itself can determine whether image portions associated with the decision-making of a given task are salient enough with respect to the model input (e.g. whether these image portions are attended by active nodes, whether they have enough corresponding pixels, whether they are fully encoded by the active modes, etc.), so as to adjust the quantity (e.g. a single image frame versus a series of image frames), type (e.g. viewing angle of the image, e.g., driver's perspective or wide-angle perspective), or format (e.g. high-definition image, color image, grayscale image, heat map, etc.) of the model input, and better help the model extract useful information payloads, thereby improving the accuracy of the model inference. Alternatively, when an active node focuses on a model input part that deviates significantly from the ROI, the users, model developers, or model can save unnecessary computing resources and improve the computational efficiency involved in model inference by deactivating or removing such nodes from the network structure of the model.

It should be understood that the example described with respect to FIGS. 8-10 are merely for illustrative purposes and shall not be construed as limiting the scope of the present disclosure.

In some embodiments, the functions/features described above may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be implemented in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, Flash memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

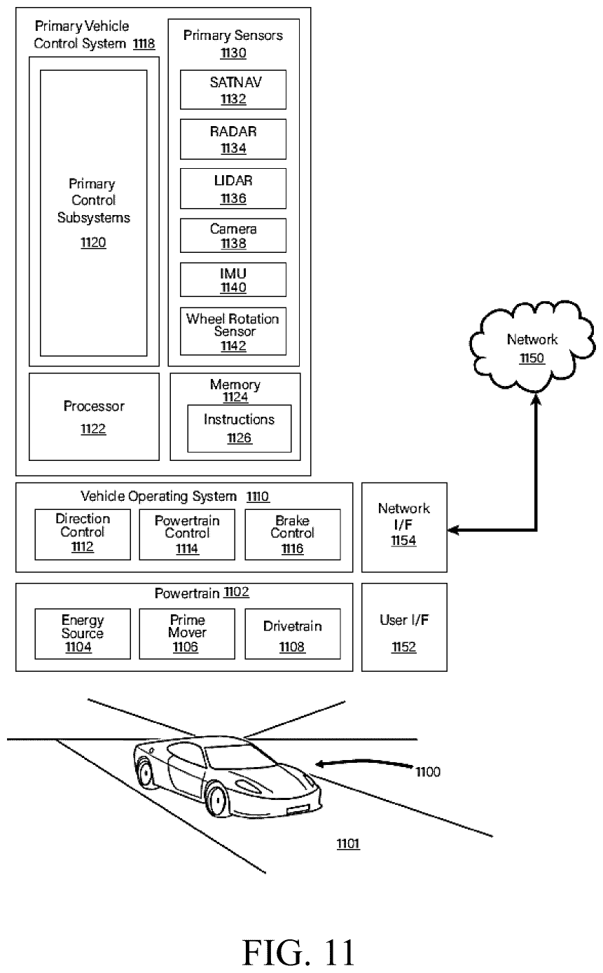

FIG. 11 illustrates an example hardware and software environment for an autonomous vehicle 1100 within which various techniques disclosed herein may be implemented. The vehicle 1100, for example, is shown driving on a road 1101, and the vehicle 1100 may include a powertrain 1102 including a prime mover 1106 powered by an energy source 1104 and capable of providing power to a drivetrain 1108, and a vehicle operating system 1110 including a direction control 1112, a powertrain control 1114 and a brake control 1116. The vehicle 1100 may be implemented as any number of different types of vehicles, including vehicles capable of transporting people and/or cargo, and capable of traveling by land, by sea, by air, underground, undersea and/or in space, and it will be appreciated that the aforementioned components 1102-1116 can vary widely based upon the type of vehicle within which these components are utilized.

For simplicity, the embodiments discussed hereinafter will focus on a wheeled land vehicle such as a car, van, truck, bus, motorcycle, All-Terrain Vehicle (ATV), etc. In such embodiments, the energy source 1104 may include, for example, a fuel system (e.g., providing gasoline, diesel, hydrogen, etc.), a battery system, solar panels, or other renewable energy sources, and/or a fuel cell system. The prime mover 1106 may include one or more electric motors and/or an internal combustion engine (among others). The drivetrain 1108 may include wheels and/or tires along with a transmission and/or any other mechanical drive components suitable for converting the output of the prime mover 1106 into vehicular motion, and one or more brakes configured to controllably stop or slow the vehicle 1100 and direction or steering components suitable for controlling the trajectory of the vehicle 1100 (e.g., a rack and pinion steering linkage enabling one or more wheels of the vehicle 1100 to pivot about a generally vertical axis to vary an angle of the rotational planes of the wheels relative to the longitudinal axis of the vehicle). In some embodiments, combinations of powertrains and energy sources may be used (e.g., in the case of electric/gas hybrid vehicles), and in other embodiments multiple electric motors (e.g., dedicated to individual wheels or axles) may be used as the prime mover 1106. In the case of a hydrogen fuel cell implementation, the prime mover 1106 may include one or more electric motors, and the energy source 1104 may include a fuel cell system powered by hydrogen fuel.

The direction control 1112 may include one or more actuators or sensors for controlling and receiving feedback from the direction or steering components to enable the vehicle 1100 to follow a desired trajectory. The powertrain control 1114 may be configured to control the output of the powertrain 1102, (e.g., to control the output power of the prime mover 1106, to control a gear of a transmission in the drivetrain 1108, etc.), thereby controlling a speed and/or direction of the vehicle 1100. The brake control 1116 may be configured to control one or more brakes that slow or stop the vehicle 1100, e.g., disk or drum brakes coupled to the wheels of the vehicle.

Other vehicle types, including but not limited to all-terrain or tracked vehicles, and construction equipment, may utilize different powertrains, drivetrains, energy sources, direction controls, powertrain controls and brake controls. Moreover, in some embodiments, some of the components can be combined, e.g., where directional control of a vehicle is primarily handled by varying an output of one or more prime movers. Therefore, embodiments disclosed herein are not limited to the particular application of the herein-described techniques in an autonomous, wheeled, land vehicle.

In the illustrated embodiment, full or semi-autonomous control over the vehicle 1100 is implemented in a primary vehicle control system 1118, which may include one or more processors 1122 and one or more memories 1124, with each processor 1122 configured to execute program code instructions 1126 stored in the memory 1124. The processors 1122 may include, for example, graphics processing unit(s) (GPU) and/or central processing unit(s) (CPU). The processors 1122 may also include an application-specific integrated circuit (ASICs), other chipsets, logic circuits and/or data processing devices. The memory 1124 may be used to load and store data and/or instructions, for example, for the control system 1118. The memory 1124 may include any combination of suitable volatile memory, for example, read-only memory (ROM), dynamic random-access memory (DRAM), a random-access memory (RAM), non-volatile memory such as a flash memory, a memory card, a storage medium and/or other storage devices. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

Sensors 1130 may include various sensors suitable for collecting information from a vehicle's surrounding environment for use in controlling the operation of the vehicle 1100. For example, the sensors 1130 may include one or more detection and ranging sensors (e.g., a RADAR sensor 1134, a LIDAR sensor 1136, or both), a satellite navigation (SATNAV) sensor 1132, e.g., compatible with any of various satellite navigation systems such as GPS (Global Positioning System), GLONASS (Globalnaya Navigazionnaya Sputnikovaya Sistema, or Global Navigation Satellite System), BeiDou Navigation Satellite System (BDS), Galileo, Compass, etc. The Radio Detection and Ranging (RADAR) 1134 and Light Detection and Ranging (LIDAR) sensors 1136, as well as a digital camera 1138 (which may include various types of image capture devices capable of capturing still and/or video imagery), may be used to sense stationary and moving objects within the immediate vicinity of a vehicle. The camera 1138 can be a monographic or stereographic camera and can record still and/or video images. The SATNAV sensor 1132 can be used to determine the location of the vehicle on the Earth using satellite signals. The sensors 1130 can optionally include an Inertial Measurement Unit (IMU) 1140. The IMU 1140 may include multiple gyroscopes and accelerometers capable of detecting linear and rotational motion of the vehicle 1100 in three directions. One or more other types of sensors, such as wheel rotation sensors/encoders 1142 may be used to monitor the rotation of one or more wheels of vehicle 1100.

In a variety of embodiments, a removable hardware pod is vehicle agnostic and therefore can be mounted on a variety of non-autonomous vehicles including: a car, a bus, a van, a truck, a moped, a tractor trailer, a sports utility vehicle, etc. While autonomous vehicles generally contain a full sensor suite, in many embodiments a removable hardware pod can contain a specialized sensor suite, often with fewer sensors than a full autonomous vehicle sensor suite, which can include: an IMU, 3-D positioning sensors, one or more cameras, a LIDAR unit, etc. Additionally or alternatively, the hardware pod can collect data from the non-autonomous vehicle itself, for example, by integrating with the vehicle's CAN bus to collect a variety of vehicle data including: vehicle speed data, braking data, steering control data, etc. In some embodiments, removable hardware pods can include a computing device which can aggregate data collected by the removable pod sensor suite as well as vehicle data collected from the CAN bus, and upload the collected data to a computing system for further processing (e.g., uploading the data to the cloud). In many embodiments, the computing device in the removable pod can apply a time stamp to each instance of data prior to uploading the data for further processing. Additionally or alternatively, one or more sensors within the removable hardware pod can apply a time stamp to data as it is collected (e.g., a lidar unit can provide its own time stamp). Similarly, a computing device within an autonomous vehicle can apply a time stamp to data collected by the autonomous vehicle's sensor suite, and the time stamped autonomous vehicle data can be uploaded to the computer system for additional processing.

The outputs of sensors 1130 may be provided to a set of primary control subsystems 1120, including, for example, a localization subsystem, a perception subsystem, a planning subsystem, and a control subsystem. The localization subsystem is principally responsible for precisely determining the location and orientation (also sometimes referred to as “pose” or “pose estimation”) of the vehicle 1100 within its surrounding environment, and generally within some frame of reference. In some embodiments, the pose is stored within the memory 1124 as localization data. In some embodiments, a surface model is generated from a high-definition map and stored within the memory 1124 as surface model data. In some embodiments, the detection and ranging sensors store their sensor data in the memory 1124, (e.g., radar data point cloud is stored as radar data). In some embodiments, calibration data is stored in the memory 1124. The perception subsystem is principally responsible for detecting, tracking, and/or identifying objects within the environment surrounding vehicle 1100. A machine learning model, such as the one discussed above in accordance with some embodiments, can be utilized in planning a vehicle trajectory. The control subsystem 1120 is principally responsible for generating suitable control signals for controlling the various controls in the vehicle control system 1118 in order to implement the planned trajectory of the vehicle 1100. Similarly, a machine learning model can be utilized to generate one or more signals to control the autonomous vehicle 1100 to implement the planned trajectory.

It will be appreciated that the collection of components illustrated in FIG. 11 for the vehicle control system 1118 is merely one example. Individual sensors may be omitted in some embodiments. Additionally, or alternatively, in some embodiments, multiple sensors of the same types illustrated in FIG. 11 may be used for redundancy and/or to cover different regions around a vehicle. Moreover, there may be additional sensors of other types beyond those described above to provide actual sensor data related to the operation and environment of the wheeled land vehicle. Likewise, different types and/or combinations of control subsystems may be used in other embodiments. Further, while the primary control subsystems 1120 is illustrated as being separate from the processor 1122 and memory 1124, it will be appreciated that in some embodiments, some or all of the functionality of the primary control subsystems 1120 may be implemented with program code instructions 1126 resident in one or more memories 1124 and executed by one or more processors 1122, and the primary control subsystems 1120 may in some instances be implemented using the same processor(s) and/or memory. Subsystems may be implemented at least in part using various dedicated circuit logic, various processors, various field programmable gate arrays (FPGA), various application-specific integrated circuits (ASIC), various real time controllers, and the like, as noted above, multiple subsystems may utilize circuitry, processors, sensors, and/or other components. Further, the various components in the vehicle control system 1118 may be networked in various manners.

For example, the vehicle 1100 may include one or more network interfaces, e.g., network interface 1154, suitable for communicating with one or more networks 1150 (e.g., a LAN, a WAN, a wireless network, and/or the Internet, among others) to permit the communication of information with other vehicles, computers and/or electronic devices, including, for example, a central service, such as a cloud service, from which the vehicle 1100 receives environmental and other data for use in autonomous control thereof.

In addition, for additional storage, the vehicle 1100 may also include one or more mass storage devices, e.g., a floppy or other removable disk drive, a hard disk drive, a direct access storage device (DASD), an optical drive (e.g., a CD drive, a DVD drive, etc.), a solid-state storage drive (SSD), network attached storage, a storage area network, and/or a tape drive, among others. Furthermore, the vehicle 1100 may include a user interface 1152 to enable the vehicle 1100 to receive a number of inputs from and generate outputs for a user or operator, e.g., one or more displays, touchscreens, voice and/or gesture interfaces, buttons, and other tactile controls, etc. Otherwise, user input may be received via another computer or electronic device, e.g., via an app on a mobile device or via a web interface, e.g., from a remote operator.

Systems and methods are disclosed herein related to object detection and detection confidence. Disclosed approaches may be suitable for autonomous driving, but may also be used for other applications, such as robotics, video analysis, weather forecasting, medical imaging, etc. The present disclosure may be described with respect to an example autonomous vehicle 1100. Although the present disclosure primarily provides examples using autonomous vehicles, other types of devices may be used to implement those various approaches described herein, such as robots, camera systems, weather forecasting devices, medical imaging devices, etc. In addition, these approaches may be used for controlling autonomous vehicles, or for other purposes, such as, without limitation, video surveillance, video or image editing, video or image search or retrieval, object tracking, weather forecasting (e.g., using radar data), and/or medical imaging (e.g., using ultrasound or Magnetic Resonance Imaging (MRI) data).

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit is basically the same. For easy description and simplicity, these working processes will not be detailed.

If the software function unit is realized and used and sold as a product, it may be stored in a readable storage medium in a computer. Based on this understanding, the technical plan proposed by the present disclosure may be essentially or partially realized as the form of a software product. Or one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a ROM, a RAM, a floppy disk, or other kinds of media capable of storing program codes. While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by people skilled in the art that the embodiments of the disclosure are not limited by what has been particularly shown and described hereinabove. Rather the scope of the embodiments of the disclosure is defined by the appended claims and equivalents thereof.

The previous description of the disclosed embodiments is provided to enable others to make or use the disclosed subject matter. Various modifications to these embodiments will be readily apparent, and the generic principles defined herein may be applied to other embodiments without departing from the spirit or scope of the previous description. Thus, the previous description is not intended to be limited to the embodiments shown herein but is to be accorded the widest scope consistent with the principles and novel features disclosed herein. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.” It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order and are not meant to be limited to the specific order or hierarchy presented.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example. The foregoing method descriptions and the process flow diagrams are provided merely as illustrative examples and are not intended to require or imply that the blocks of various examples must be performed in the order presented. As will be appreciated, the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular. The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. The hardware used to implement the various illustrative logics, logical blocks, modules, and circuits described in connection with the examples disclosed herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

Further Embodiments are listed below.

Embodiment 1. A method of visualizing neurons in an Artificial Intelligence (AI) model for autonomous driving, including obtaining, from a number of neurons of the AI model for a task, one or more neurons; determining, for each of the one or more neurons, a respective Region of Interest (ROI) of an input related to the task, wherein the respective ROI is encoded by the one or more neurons for the task; and producing a human-interpretable representation of the determined respective ROI of the input for at least a portion of the one or more neurons, by applying a first operation including Layer-wise Relevance Propagation (LRP).

Embodiment 2. The method of Embodiment 1, wherein the input is collected by a sensor, a recorded human driving database, and/or a cloud storage for the task.

Embodiment 3. The method of Embodiments 1-2, wherein the input is a processed image frame, and the respective Region of Interest (ROI) for each of the one or more neurons includes a set of pixels of the processed image frame that corresponds to the respective ROI.

Embodiment 4. The method of Embodiments 1-3, wherein the input is a sequence of processed image frames, and the respective Region of Interest (ROI) for each of the one or more neurons includes a union of sets of pixels of the sequence of processed image frames that correspond to a respective sub-region of interest (sub-ROI) of each processed image frame in the sequence of processed image frames, respectively.

Embodiment 5. The method of Embodiments 1-4, wherein the producing of the human-interpretable representation includes applying a second operation including Visual Back-Propagation (VBP) to identify a specific ROI from the determined respective ROI that contributed most to a prediction made by the Artificial Intelligence (AI) model to complete the task in order to improve computational efficiency and enhance model accuracy.

Embodiment 6. The method of Embodiments 1-5, wherein: the Visual Back-Propagation (VBP) is applied sequentially after the Layer-wise Relevance Propagation (LRP), and the LRP is applied to identify the one or more neurons from the number of neurons that contributed most to a prediction made by the Artificial Intelligence (AI) model to complete the task in order to improve computational efficiency and enhance model accuracy.

Embodiment 7. The method of Embodiments 1-6, wherein the Artificial Intelligence (AI) model includes a mixing block and a model backbone.

Embodiment 8. The method of Embodiments 1-7, wherein the applying of the first operation and the second operation includes applying the Layer-wise Relevance Propagation (LRP) through the mixing block to obtain weight masks for feature maps of the one or more neurons; weighting the feature maps of the one or more neurons using the weight masks to obtain weighted feature maps of the one or more neurons; and applying the Visual Back-Propagation (VBP) to back-propagate the weighted feature maps of the one or more neurons through the model backbone.

Embodiment 9. The method of Embodiments 1-8, wherein the input is a spectrogram of a speech segment.

Embodiment 10. A non-transitory computer-readable storage medium having stored thereon instructions that, when executed by one or more processors, cause the one or more processors to execute operations including obtaining, from a number of neurons of the AI model for a task, one or more neurons; determining, for each of the one or more neurons, a respective Region of Interest (ROI) of an input related to the task, wherein the respective ROI is encoded by the one or more neurons for the task; and producing a human-interpretable representation of the determined respective ROI of the input for at least a portion of the one or more neurons, by applying a first operation including Layer-wise Relevance Propagation (LRP).

Embodiment 11. The non-transitory computer-readable storage medium of Embodiment 10, wherein the input is collected by a sensor, a recorded human driving database, and/or a cloud storage for the task.

Embodiment 12. The non-transitory computer-readable storage medium of Embodiments 10-11, wherein the input is a processed image frame, and the respective Region of Interest (ROI) for each of the one or more neurons includes a set of pixels of the processed image frame that corresponds to the respective ROI.

Embodiment 13. The non-transitory computer-readable storage medium of Embodiments 10-12, wherein the input is a sequence of processed image frames, and the respective Region of Interest (ROI) for each of the one or more neurons includes a union of sets of pixels of the sequence of processed image frames that correspond to a respective sub-region of interest (sub-ROI) of each processed image frame in the sequence of processed image frames, respectively.

Embodiment 14. The non-transitory computer-readable storage medium of Embodiments 10-13, wherein the producing of the human-interpretable representation includes applying a second operation including Visual Back-Propagation (VBP) to identify a specific ROI from the determined respective ROI that contributed most to a prediction made by the Artificial Intelligence (AI) model to complete the task in order to improve computational efficiency and enhance model accuracy.

Embodiment 15. The non-transitory computer-readable storage medium of Embodiments 10-14, wherein the Visual Back-Propagation (VBP) is applied sequentially after the Layer-wise Relevance Propagation (LRP), and the LRP is applied to identify the one or more neurons from the number of neurons that contributed most to a prediction made by the Artificial Intelligence (AI) model to complete the task in order to improve computational efficiency and enhance model accuracy.

Embodiment 16. The non-transitory computer-readable storage medium of Embodiments 10-15, wherein the Artificial Intelligence (AI) model includes a mixing block and a model backbone.

Embodiment 17. The non-transitory computer-readable storage medium of Embodiments 10-16, wherein the applying of the first operation and the second operation includes applying the Layer-wise Relevance Propagation (LRP) through the mixing block to obtain weight masks for feature maps of the one or more neurons; weighting the feature maps of the one or more neurons using the weight masks to obtain weighted feature maps of the one or more neurons; and applying the Visual Back-Propagation (VBP) to back-propagate the weighted feature maps of the one or more neurons through the model backbone.

Embodiment 18. The non-transitory computer-readable storage medium of Embodiments 10-17, wherein the input is a spectrogram of a speech segment.

Embodiment 19. A computer-implemented system including one or more processors; and one or more memory devices that store instructions that, when executed by the one or more processors, cause the one or more processors to execute operations including obtaining, from a number of neurons of the AI model for a task, one or more neurons; determining, for each of the one or more neurons, a respective Region of Interest (ROI) of an input related to the task, wherein the respective ROI is encoded by the one or more neurons for the task; and producing a human-interpretable representation of the determined respective ROI of the input for at least a portion of the one or more neurons, by applying a first operation including Layer-wise Relevance Propagation (LRP).

Embodiment 20. The system of Embodiment 19, wherein the producing of the human-interpretable representation includes applying a second operation including Visual Back-Propagation (VBP) to identify a specific ROI from the determined respective ROI that contributed most to a prediction made by the Artificial Intelligence (AI) model to complete the task in order to improve computational efficiency and enhance model accuracy.

What is claimed is:

1. A method of visualizing neurons in an Artificial Intelligence (AI) model for autonomous driving, comprising:
obtaining, from a number of neurons of the AI model for a task, one or more neurons;
determining, for each of the one or more neurons, a respective Region of Interest (ROI) of an input related to the task, wherein the respective ROI is encoded by the one or more neurons for the task; and
producing a human-interpretable representation of the determined respective ROI of the input for at least a portion of the one or more neurons, by applying a first operation including Layer-wise Relevance Propagation (LRP).

2. The method of claim 1, wherein the input is collected by a sensor, a recorded human driving database, and/or a cloud storage for the task.

3. The method of claim 1, wherein the input is a processed image frame, and the respective Region of Interest (ROI) for each of the one or more neurons includes a set of pixels of the processed image frame that corresponds to the respective ROI.

4. The method of claim 1, wherein the input is a sequence of processed image frames, and the respective Region of Interest (ROI) for each of the one or more neurons includes a union of sets of pixels of the sequence of processed image frames that correspond to a respective sub-region of interest (sub-ROI) of each processed image frame in the sequence of processed image frames, respectively.

5. The method of claim 1, wherein the producing of the human-interpretable representation includes applying a second operation including Visual Back-Propagation (VBP) to identify a specific ROI from the determined respective ROI that contributed most to a prediction made by the Artificial Intelligence (AI) model to complete the task in order to improve computational efficiency and enhance model accuracy.

6. The method of claim 5, wherein the Visual Back-Propagation (VBP) is applied sequentially after the Layer-wise Relevance Propagation (LRP), and the LRP is applied to identify the one or more neurons from the number of neurons that contributed most to a prediction made by the Artificial Intelligence (AI) model to complete the task in order to improve computational efficiency and enhance model accuracy.

7. The method of claim 6, wherein the Artificial Intelligence (AI) model includes a mixing block and a model backbone.

8. The method of claim 7, wherein the applying of the first operation and the second operation includes:
applying the Layer-wise Relevance Propagation (LRP) through the mixing block to obtain weight masks for feature maps of the one or more neurons;
weighting the feature maps of the one or more neurons using the weight masks to obtain weighted feature maps of the one or more neurons; and
applying the Visual Back-Propagation (VBP) to back-propagate the weighted feature maps of the one or more neurons through the model backbone.

9. The method of claim 1, wherein the input is a spectrogram of a speech segment.

10. A non-transitory computer-readable storage medium having stored thereon instructions that, when executed by one or more processors, cause the one or more processors to execute operations comprising:
obtaining, from a number of neurons of the AI model for a task, one or more neurons;
determining, for each of the one or more neurons, a respective Region of Interest (ROI) of an input related to the task, wherein the respective ROI is encoded by the one or more neurons for the task; and
producing a human-interpretable representation of the determined respective ROI of the input for at least a portion of the one or more neurons, by applying a first operation including Layer-wise Relevance Propagation (LRP).

11. The non-transitory computer-readable storage medium of claim 10, wherein the input is collected by a sensor, a recorded human driving database, and/or a cloud storage for the task.

12. The non-transitory computer-readable storage medium of claim 10, wherein the input is a processed image frame, and the respective Region of Interest (ROI) for each of the one or more neurons includes a set of pixels of the processed image frame that corresponds to the respective ROI.

13. The non-transitory computer-readable storage medium of claim 10, wherein the input is a sequence of processed image frames, and the respective Region of Interest (ROI) for each of the one or more neurons includes a union of sets of pixels of the sequence of processed image frames that correspond to a respective sub-region of interest (sub-ROI) of each processed image frame in the sequence of processed image frames, respectively.

14. The non-transitory computer-readable storage medium of claim 10, wherein the producing of the human-interpretable representation includes applying a second operation including Visual Back-Propagation (VBP) to identify a specific ROI from the determined respective ROI that contributed most to a prediction made by the Artificial Intelligence (AI) model to complete the task in order to improve computational efficiency and enhance model accuracy.

15. The non-transitory computer-readable storage medium of claim 14, wherein the Visual Back-Propagation (VBP) is applied sequentially after the Layer-wise Relevance Propagation (LRP), and the LRP is applied to identify the one or more neurons from the number of neurons that contributed most to a prediction made by the Artificial Intelligence (AI) model to complete the task in order to improve computational efficiency and enhance model accuracy.

16. The non-transitory computer-readable storage medium of claim 15, wherein the Artificial Intelligence (AI) model includes a mixing block and a model backbone.

17. The non-transitory computer-readable storage medium of claim 16, wherein the applying of the first operation and the second operation includes:
applying the Layer-wise Relevance Propagation (LRP) through the mixing block to obtain weight masks for feature maps of the one or more neurons;
weighting the feature maps of the one or more neurons using the weight masks to obtain weighted feature maps of the one or more neurons; and
applying the Visual Back-Propagation (VBP) to back-propagate the weighted feature maps of the one or more neurons through the model backbone.

18. The non-transitory computer-readable storage medium of claim 10, wherein the input is a spectrogram of a speech segment.

19. A computer-implemented system comprising:
one or more processors; and
one or more memory devices that store instructions that, when executed by the one or more processors, cause the one or more processors to execute operations comprising:
obtaining, from a number of neurons of the AI model for a task, one or more neurons;
determining, for each of the one or more neurons, a respective Region of Interest (ROI) of an input related to the task, wherein the respective ROI is encoded by the one or more neurons for the task; and
producing a human-interpretable representation of the determined respective ROI of the input for at least a portion of the one or more neurons, by applying a first operation including Layer-wise Relevance Propagation (LRP).

20. The system of claim 19, wherein the producing of the human-interpretable representation includes applying a second operation including Visual Back-Propagation (VBP) to identify a specific ROI from the determined respective ROI that contributed most to a prediction made by the Artificial Intelligence (AI) model to complete the task in order to improve computational efficiency and enhance model accuracy.
